(19) United States
(12) Patent Application Publication
(10) Pub. No.: US 2017/0295209 A1
(43) Pub. Date: Oct. 12, 2017

(54) Subscription for Communication Attributes

(71) Applicant: Microsoft Technology Licensing, LLC, Redmond, WA (US)

(72) Inventors: Pascal Francis Menezes, Bellevue, WA (US); Gunter Leeb, Redmond, WA (US); Amer Aref Hassan, Kirkland, WA (US)

(21) Appl. No.: 15/096,023

(22) Filed: Apr. 11, 2016

(51) Int. Cl. H04L 29/06; H04L 29/12; H04L 29/08

(52) U.S. Cl. CPC H04L 65/1069; H04L 67/289; H04L 61/35

(57) ABSTRACT

Techniques for subscription for communication attributes are described. According to various embodiments, communication attributes represent attributes pertaining to communication sessions between different endpoints. According to various embodiments, a client network involved in a communication system can subscribe to receive various communication attributes for various subnetworks (“subnets”) of the client network. According to one or more embodiments, various actions can be performed based on communication attributes.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication and Collaboration (UC&C) systems.

While UC&C systems provide for increased flexibility in communications, they also present a number of implementation challenges. For instance, a UC&C system typically utilizes multiple interconnected networks to route various communications. Since different networks may be managed by different entities, challenges thus arise in managing communications quality for communications that are routed among independently managed networks. Further, UC&C is typically implemented via software that can be loaded on mobile devices, e.g., tablets, smartphones, laptops, and so forth. Thus, techniques for managing UC&C communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for subscription for communication attributes are described. According to various embodiments, communication attributes represent attributes pertaining to communication sessions between different endpoints. According to various embodiments, a client network involved in a communication system can subscribe to receive various communication attributes for various subnetworks (“subnets”) of the client network. According to one or more embodiments, various actions can be performed based on communication attributes.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an environment in an example implementation that is operable to employ techniques discussed herein.

FIG. 2 depicts an example implementation scenario for subscribing to receive communication attributes in accordance with one or more embodiments.

FIG. 3 depicts an example implementation scenario for generating attribute subscriptions in accordance with one or more embodiments.

FIG. 4 depicts an example implementation scenario for generating attribute batches based on attribute subscriptions in accordance with one or more embodiments.

FIG. 5 is a flow diagram that describes steps in a method for subscribing to network attributes in accordance with one or more embodiments.

FIG. 6 depicts an example implementation scenario for communicating attribute batches in accordance with one or more embodiments.

FIG. 7 is a flow diagram that describes steps in a method for aggregating attribute batches in accordance with one or more embodiments.

FIG. 8 is a flow diagram that describes steps in a method for subscribing to receive communication attributes in accordance with one or more embodiments.

FIG. 9 illustrates an example system and computing device as described with reference to FIG. 1, which are configured to implement embodiments of techniques described herein.

### DETAILED DESCRIPTION

### Overview

Techniques for subscription for communication attributes are described. According to various implementations, communication attributes represent attributes pertaining to communication sessions between different endpoints. Generally, a communication session refers to an exchange of communication media between different communication endpoints, such as in real-time. Examples of a communication session include a Voice over Internet Protocol (VoIP) call, a video call, text messaging, a file transfer, content sharing, and/or combinations thereof. In at least some embodiments, a communication session represents a Unified Communication and Collaboration (UC&C) session.

According to various implementations, communication attributes represent various descriptive information and state information for entities and data flows across a communication system. Examples of different communication attributes are described below.

According to various implementations, a client network involved in a communication system can subscribe to receive various communication attributes for various subnetworks (“subnets”) of the client network. For instance, the client network is divided into multiple subnets that each correspond to a different network domain of the client network. Thus, the client network can request different sets of communication attributes for different subnets to enable precise management and optimization of network performance of the client network.

According to one or more implementations, various actions can be performed based on communication attributes. For instance, a network controller for a communication network can change a network configuration setting and/or a communication routing path to optimize network performance and/or communication session performance. As another example, a client device can adjust its own settings based on a communication attribute to optimize its performance, such as part of a communication session. As yet another example, a communication service can propagate a communication attribute among different networks and devices served by the communication service, such as to enable optimization of the different networks and devices. Thus, techniques described herein provide extensible ways of enlightening network entities with communication attributes for performance optimization and error mitigation across a communication system.

In the following discussion, an example environment is first described that is operable to employ techniques described herein. Next, a section entitled “Propagating Communication Attributes” discusses some example ways for propagating communication attributes in accordance with one or more embodiments. Following this, a section entitled “Example Implementation Scenarios” describes some example implementation scenarios in accordance with one or more embodiments. Next, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

### Example Environment

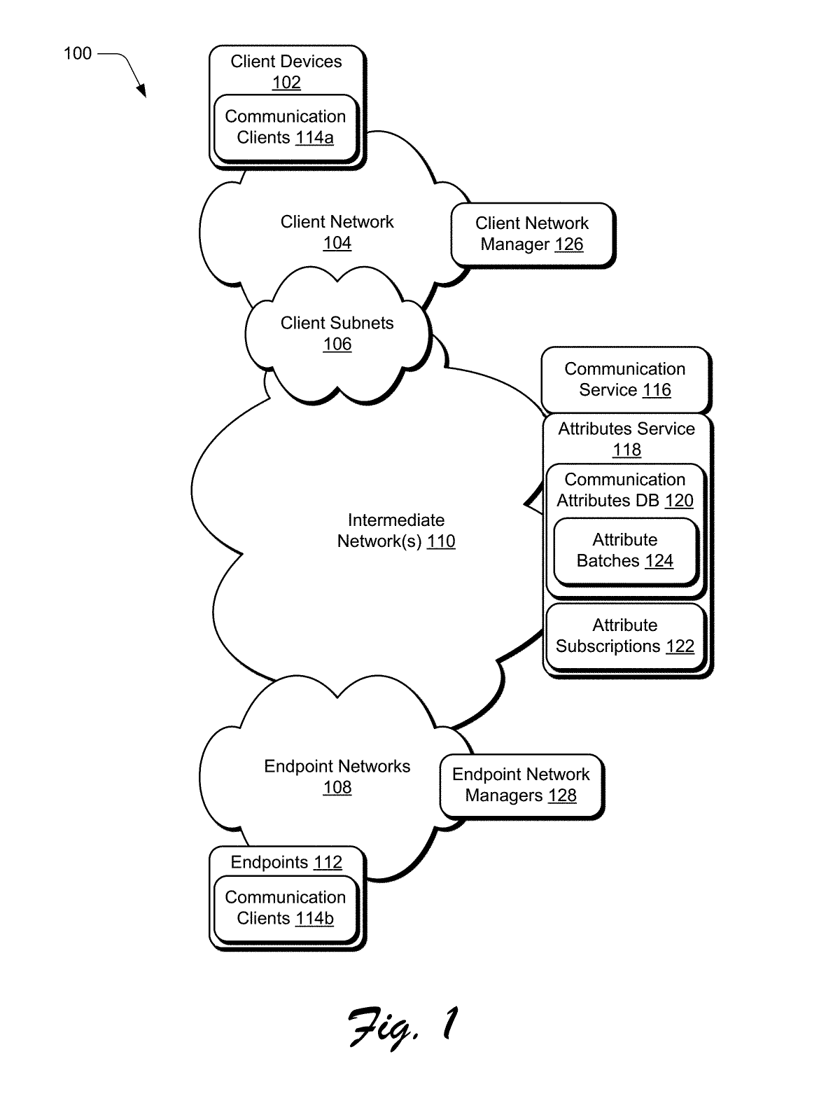

FIG. 1 is an illustration of an environment 100 in an example implementation that is operable to employ techniques for subscription for communication attributes described herein. Generally, the environment 100 represents a communication system that includes various devices, services, and networks that enable communication via a variety of different modalities. For instance, the environment 100 includes client devices 102 connected to a client network 104. The client devices 102 may be configured in a variety of ways, such as a traditional computer (e.g., a desktop personal computer, laptop computer, and so on), a mobile station, a cellular phone, an entertainment appliance, a smartphone, a wearable device, a netbook, a game console, a handheld device (e.g., a tablet), a smart appliance (e.g., an Internet of Things (“IoT”) device, and so forth.

The client network 104 is representative of a network that provides the client devices 102 with connectivity to various other networks and/or services, such as the Internet. In at least some implementations, the client network 104 represents a network implemented for a particular entity, such as an enterprise entity, and educational entity, a government entity, and so forth. The client network 104, for example, represents a corporate network deployed for a particular entity. The client network 104 may provide the client devices 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth.

The client network 104 includes client subnets 106, which are representative of different subnetworks and/or network domains of the client network 104. Different instances of the client devices 102, for instance, can be connected to different respective instances of the client subnets 106 to enable communication over the client network 104.

The client network 104 is connected to endpoint networks 108 via one or more intermediate networks 110. The endpoint networks 108 are representative of different types and instances of wired and wireless networks that may be implemented and managed by different respective entities and according to a variety of different networking technologies.

According to various implementations, connectivity between the client network 104 and the endpoint networks 108 provides different communication paths between the client devices 102 and endpoints (“endpoints”) 112. The endpoints 112 are representative of different devices with which the client devices 102 may communicate.

According to various implementations, communication between the client devices 102 and the endpoints 112 is facilitated via communication clients 114a of the client devices 102, and communication clients 114b of the endpoints 112. Generally, the communication clients 114a, 114b are representative of functionalities to enable different forms of communication via the client devices 102 and the endpoints 112. Examples of the communication clients 114a, 114b include a voice communication application (e.g., a VoIP client), a video communication application, a messaging application, a content sharing application, a UC&C application, and combinations thereof. The communication clients 114a, 114b for instance, enable different communication modalities to be combined to provide diverse communication scenarios.

In at least some implementations, the communication clients 114a, 114b represent interfaces to a communication service 116. Generally, the communication service 116 is representative of a service to perform various tasks for management of communication between the client devices 102 and the endpoints 112. The communication service 116, for instance, can manage initiation, moderation, and termination of communication sessions between the communication clients 114a, 114b.

The communication service 116 maintains a presence across many different networks and can be implemented according to a variety of different architectures, such as a cloud-based service, a distributed service, a web-based service, and so forth. Examples of the communication service 116 include a VoIP service, an online conferencing service, a UC&C service, and so forth. In at least some embodiments, the communication service 116 may be implemented as or be connected to a private branch exchange (PBX) in communication with a Public Switched Telephone Network (“PSTN”) to enable voice communication between the client device 102s and other endpoints, such as the endpoints 112.

Further to techniques for subscription for communication attributes discussed herein, the client network 104 can subscribe to receive various communication attributes for communication sessions that traverse the client network 104. Accordingly, the environment 100 includes an attributes service 118, which is representative of functionality to collect attributes of communication sessions that involve the client network 104, and to provide the attributes to the client network 104. The attributes service 118 includes a communication attributes (“attributes”) database (DB) 120 that is representative of functionality to track various communication attributes for the client network 104. For instance, the attributes DB 120 may be employed to track attributes and state information for communication sessions that involve the client network 104.

Generally, the attributes DB 120 tracks communication attributes for various current and historical communication sessions, such as identifiers for individual communication sessions, client devices 102 involved in individual communication sessions, networks and subnets through which individual communication sessions are routed, performance attributes of the communication sessions, and so forth. In at least some implementations, communication attributes pertaining to a communication session can be propagated in a separate data stream from data of the communication session itself. Thus, decisions concerning handling and routing of communication session data may be made without processing and/or handling the actual communication session data.

According to one or more implementations, the attributes service 118 represents functionality that is deployed and/or managed by the communication service 116. Alternatively, the attributes service 118 can be implemented as a standalone service operated independently of the communication service 116.

As further described below, the client network 104 can define attribute subscriptions, which correspond to custom sets of communication attributes. Accordingly, the attributes service 118 maintains attribute subscriptions 122, which represent different sets of communication attributes that the client network 104 subscribes to receive. The attributes service 118 collects attribute values of communication sessions, filters the values based on the attribute subscriptions 122 to generate attribute batches 124, stores the attribute batches 124 in the communication attributes DB 120, and provides the attribute batches 124 to the client network 104.

According to various implementations, the client network 104 includes a client network manager (“client manager”) 126, which represents an interface between the client network 104 and the attributes service 118. The client manager 126, for instance, interfaces with the attributes service 118 to define the attribute subscriptions 122. The client manager 126 receives the attribute batches 124 from the attributes service 118, and performs various actions based on attribute values of the attribute batches 124. For example, the client manager 126 can utilize the attributes to change settings or configuration of the client network 104 to optimize communication session performance for communication sessions that involve the client network 104.

In at least some implementations, the client network 104 is implemented at least in part as a software-defined network (SDN). In such implementations, the client manager 126 represents an SDN manager and/or SDN controller that receives, processes, and/or propagates communication attributes.

One or more of the endpoint networks 108 include endpoint network managers (“endpoint managers”) 128, which represents interfaces between the endpoint networks 108 and the communication service 116. The attributes service 118, for instance, can request communication attributes from the endpoint managers 128 for communication sessions that involve the client network 104 and the endpoint networks 108. The endpoint managers 128 can provide the requested attributes to the attributes service 118, and the attributes service 118 can include the attributes in the attribute batches 124, such as based on the attribute subscriptions 122.

In at least some implementations, the client manager 126 and/or the endpoint managers 128 are deployed and/or managed by the attributes service 118. The client manager 126 and/or the endpoint managers 128, for instance, can be implemented as cloud-connected devices that can interface with the attributes service 118 to perform various aspects of techniques described herein.

Generally, communication attributes represent information pertaining to communication sessions across different networks in a communication system, such as information pertaining to data paths for routing session data between the client devices 102 and the endpoints 112, data about specific instances of communication sessions, attributes of networks involved in routing communication sessions, data about users that participate in communication sessions, data about infrastructure components of the different networks, and so forth. Examples of different communication attributes are presented below in the discussion of the communication API.

Various entities discussed herein may be referred to in both plural and singular implementations. When an entity is discussed in both plural and singular implementations, a reference to a singular implementation refers to an instance of the plural implementation.

Having described an example environment in which the techniques described herein may operate, consider now a discussion of example ways of propagating routing awareness in accordance with one or more embodiments.

### Propagating Communication Attributes

According to various embodiments, techniques can be employed to dynamically enlighten various entities with communication attributes, such as information about network conditions, information about communication sessions, and so forth. For instance, notification events can be generated that include various attributes of networks and communication sessions. The notification events can be propagated to different entities further to techniques for subscription for communication attributes discussed herein.

In at least some embodiments, notification events can be configured using a communication application programming interface (API) that can be leveraged to configure and communicate communication attributes to various entities involved in communication sessions. For example, the communication API can be populated with values for sets of communication attributes based on different attribute subscriptions. Consider, for instance, the following communication attributes that may be conveyed via a notification event generated using the communication API. In at least some implementations, the communication attributes listed below represent example communication attributes included in the attribute subscriptions 122 and/or the attribute batches 124.

Network Identifiers: This attribute can be leveraged to identify networks, such as networks that a communication session traverses between a client device 102 and an endpoint 112. In at least some implementations, the network identifier may include an autonomous system (AS) number that identifies a particular network. With reference to the environment 100, for instance, the network identifier may identify a particular client subnet 106, an intermediate network 110, and/or an endpoint network 108.

Timestamp: This attribute can be leveraged to specify timestamps for a start of a communication session, updates that occur during a communication session, and an end (e.g., termination) of a communication session.

Source IP Address: This attribute can be leveraged to specify an IP address for a device that is a source of media during a communication session, e.g., a device that initiates a communication session. With reference to the environment 100, for instance, the source IP address may be for a client device 102 or an endpoint 112.

Destination IP Address: This attribute can be leveraged to specify an IP address for a device that receives media as part of a communication session. With reference to the environment 100, for instance, a destination IP address may be for an endpoint 112.

Device Identifier: This attribute can be used to identify source and/or destination devices involved in a communication session using a hardware-specific identifier, such as a media access control (MAC) address and/or other unique hardware identifier.

Transport Type: This attribute can be leveraged to specify a transport type or combination of transport types for a communication session. Examples of transport types include Transmission Control Protocol (TCP), User Datagram Protocol (UDP), and so forth.

Source Port: this attribute can be leveraged to specify an identifier for a port at a source device, e.g., a source device identified by the Source IP Address referenced above.

Destination Port: This attribute can be leveraged to specify an identifier for a port at a destination device, e.g., a destination device identified by the Destination IP Address referenced above.

Media Type: This attribute can be leveraged to specify a media type and/or types that are transmitted and/or are being transmitted as part of a communication session. A communication session can involve multiple different types of media, such as audio, video, images, and combinations thereof. Thus, the Media Type attribute can be employed to identify media types in a communication session.

Bandwidth Estimation: This attribute can be leveraged to specify an estimated bandwidth used for a communication session.

To: This attribute can be leveraged to identify a user to which media in a communication session is transmitted.

From: This attribute can be leveraged to identify a user from which media in a communication session is transmitted.

Codec: This attribute can be leveraged to specify a codec or codecs utilized as part of a communication session.

Subnet: This attribute can be leveraged to identify a subnetwork and/or set of subnetworks that a communication session is originated in and/or traverses. For instance, the client manager 126 can request communication attributes for different instances of the client subnets 106.

Personally Identifiable Information (PII): This attribute can be used to specify particular types of PII that are to be included and/or not included with a subscription to communication attributes. For instance, the PII attributes can be used to specify that no PII is to be included in a set of communication attributes. As another example, the PII attributes can be used to specify that a particular set of PII is to be included, whereas a different set of PII is to be excluded.

Error Code: This attribute can be leveraged to specify various error codes for errors that may occur as part of a communication session. For example, errors can include errors that occur during initiation the communication session, errors that occurred during a communication session, errors that occur when a communication session is terminated, and so forth.

Mean Opinion Score (MOS) Degradation: This attribute can be leveraged to specify a MOS for a communication session. The attribute, for instance, can be used to indicate that an overall quality of a communication session has decreased.

Jitter Inter-Arrival Time: This attribute can be leveraged to specify jitter values for a communication session. The attribute, for instance, can be used to indicate that a jitter value or values have increased, e.g., have exceeded a specified jitter value threshold.

Packet Loss Rate: This attribute can be leveraged to specify a packet loss rate for a communication session. The attribute, for instance, can be used to indicate that a packet loss rate has increased, e.g., has exceeded a specified packet loss rate value threshold.

Round Trip Delay (RTD): This attribute can be leveraged to specify RTD values for packets in communication sessions. The attribute, for instance, can be used to indicate that RTD values for packets have increased, e.g., have exceeded a specified RTD value threshold.

Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

Thus, various entities can subscribe to receive different values for sets of the communication attributes discussed above. In at least some implementations, attributes can be linked to particular networks and/or network components to characterize performance attributes of the networks and/or network components. Further, an entity that receives values for the attributes (e.g., the client manager 126) can utilize the attribute to optimize network and/or communication session performance.

Having described an example ways of propagating communication attributes, consider now some example implementation scenarios for propagating communication attributes in accordance with one or more embodiments.

### Example Implementation Scenarios

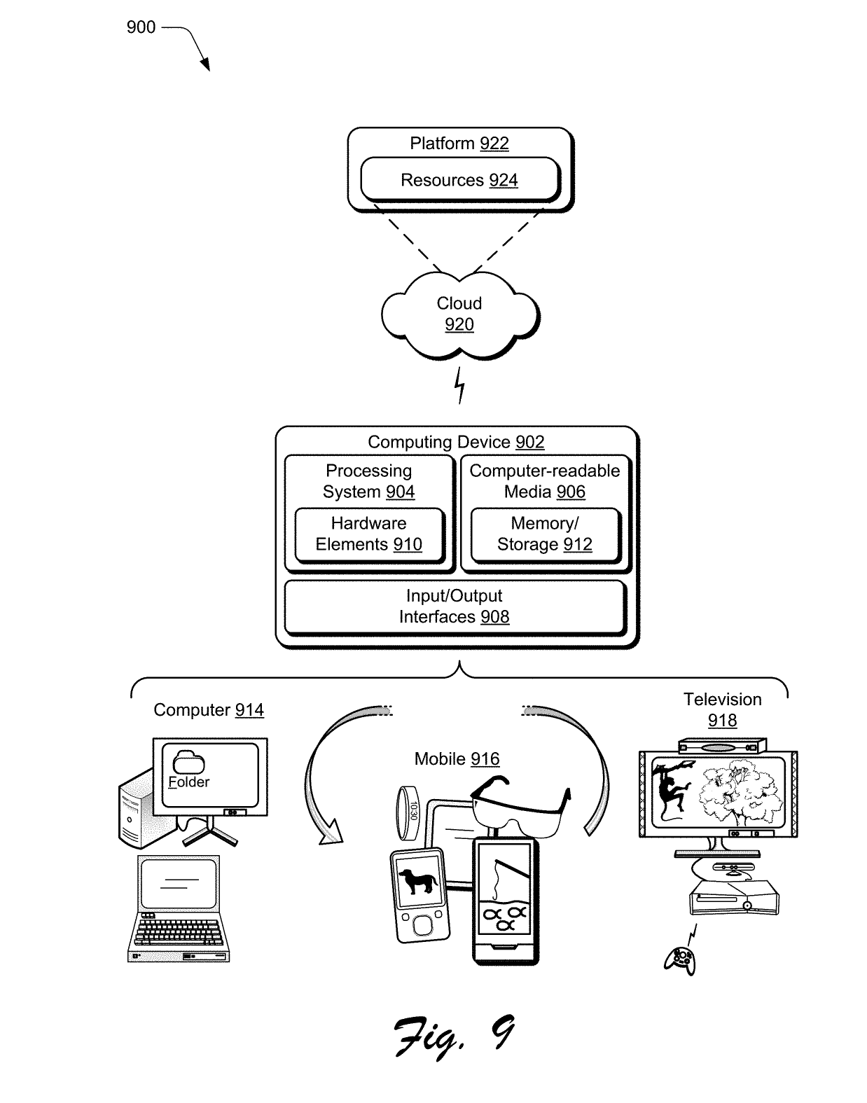

The following section describes example implementation scenarios for subscription for communication attributes in accordance with one or more implementations. The implementation scenarios may be implemented in the environment 100 discussed above, the system 900 described with reference to FIG. 9, and/or any other suitable environment.

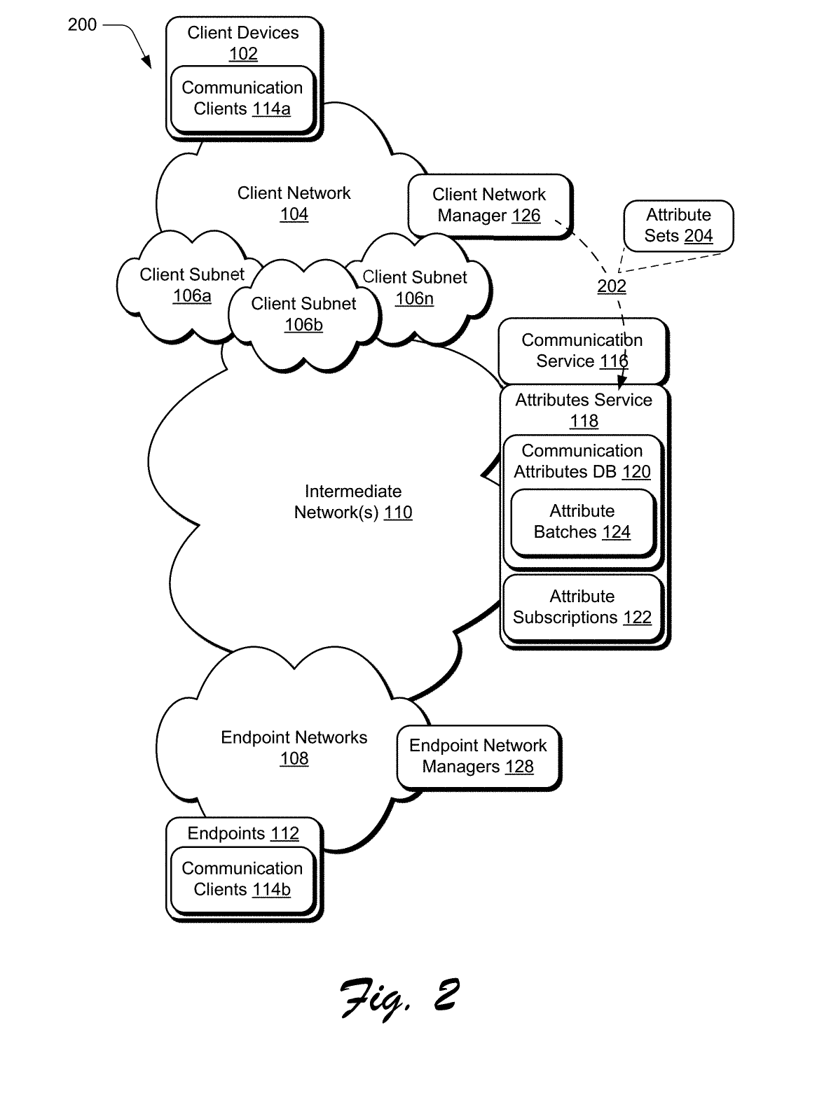

FIG. 2 illustrates an example implementation scenario 200 for subscribing to receive communication attributes in accordance with one or more implementations. The scenario 200 includes various entities and components introduced above with reference to the environment 100.

In the scenario 200, the client manager 126 communicates a subscription event 202 to the attributes service 118 requesting different attribute sets 204 that each identify different sets of communication attributes. Examples of different communication attributes are discussed above.

According to various implementations, the attribute sets 204 include different communication attributes that are specific to different instances of the client subnets 106. For instance, the attribute sets 204 identify different sets of communication attributes for a client subnet 106a, a client subnet 106b, and a client subnet 106n. Generally, the client subnets 106a-106n each represent different instances of the client subnets 106.

In response to receiving the subscription event 202, the attributes service 118 generates attribute subscriptions 122 for each of the attribute sets 204. Generally, the generated attribute subscriptions 122 are each specific to a particular instance of the client subnets 106a-106n, and each include a particular set of communication attributes. Consider, for instance, the following implementation scenario.

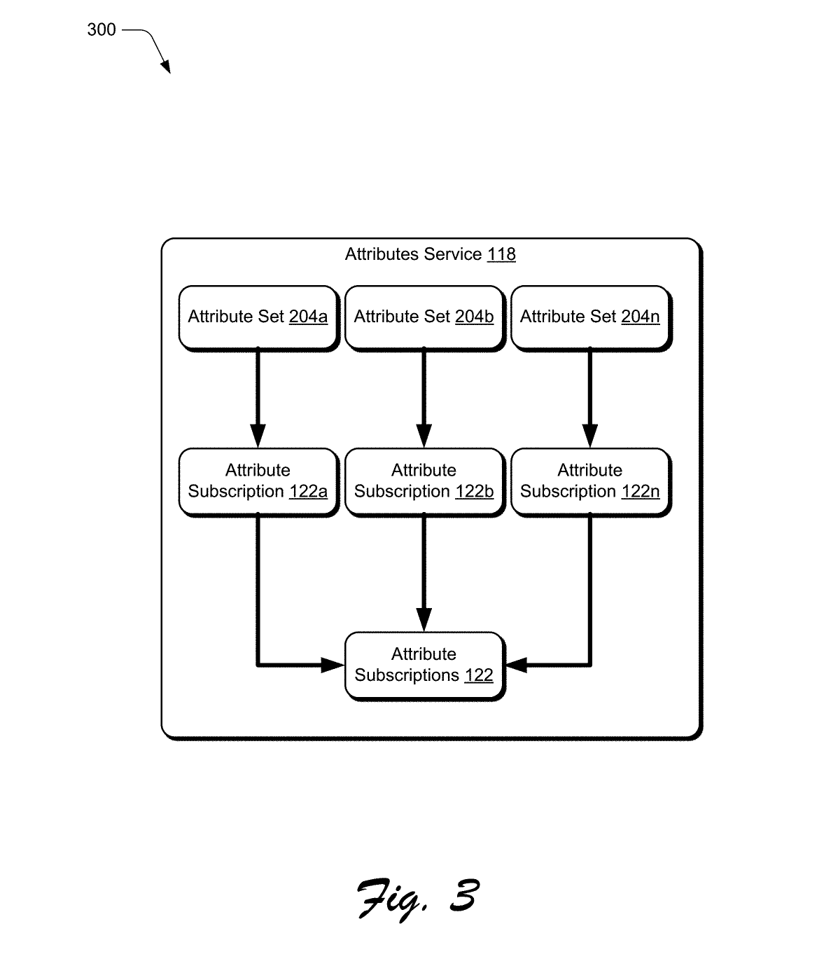

FIG. 3 depicts an example implementation scenario 300 for generating attribute subscriptions in accordance with one or more implementations. The scenario 300, for example, represents an example way of generating the attribute subscriptions 122 as discussed with reference to the scenario 200.

In the scenario 300, the attributes service 118 uses an attribute set 204a to define an attribute subscription 122a, an attribute set 204b to define an attribute subscription 122b, and an attribute set 204n to define an attribute subscription 122n. The attribute sets 204a-204n each represent an instance of the attribute sets 204 received as part of the subscription event 202 discussed above.

Generally, each of the attribute sets 204a-204n and the attribute subscriptions 122a-122n are each specific to a respective instance of the client subnets 106a-106n, respectively. Accordingly, each of the attribute subscriptions 122a-122n defines a different set of communication attributes to be extracted for each of the client subnets 106a-106n.

Continuing with the scenario 300, the attributes service 118 saves the attribute subscriptions 122a-122n are part of the attribute subscriptions 122.

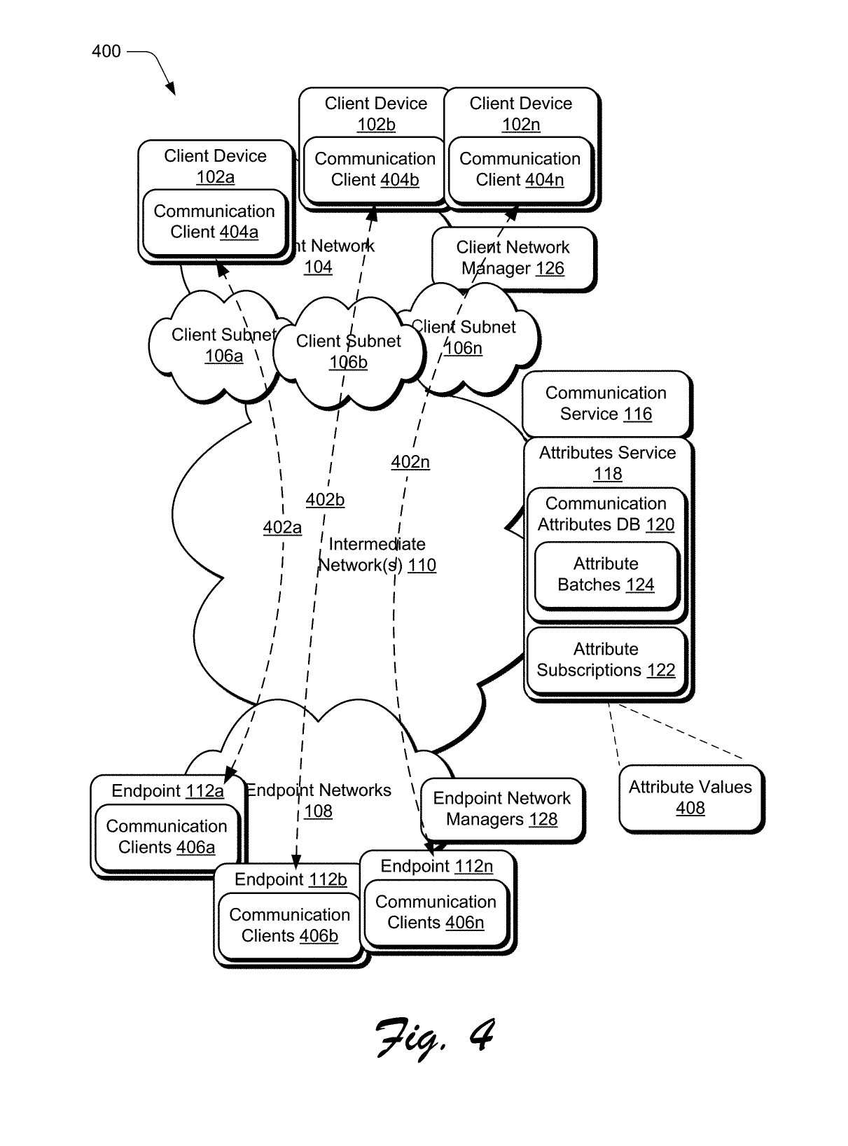

FIG. 4 depicts an example implementation scenario 400 for generating attribute batches based on attribute subscriptions in accordance with one or more implementations. The scenario 400, for example, represents an example way of generating instances of the attribute batches 124 introduced above. Further, in at least some implementations, the scenario 400 represents a continuation of the scenarios 200, 300 above.

In the scenario 400, a communication session 402a occurs between a client device 102a and an endpoint 112a over the client subnet 106a, a communication session 402b occurs between a client device 102b and an endpoint 112b over the client subnet 106b, and a communication session 402n occurs between a client device 102n and an endpoint 112n over the client subnet 106n. The communication sessions 402a, 402b, 402n, for instance, each traverse the client network 104 via different respective instances of the client subnets 106a, 106b, 106n. Generally, the communication sessions 402a-402n represent different exchanges of communication data between the client devices 102 and the endpoints 112. Examples of the communication sessions 402a-402n include voice calls (e.g., a VoIP call), video calls, online meetings, UC sessions, combinations thereof, and so forth.

In at least some implementations, the communication sessions 402a-402n are initiated and/or managed via interaction with the communication service 116. The communication session 402a, for instance, is implemented via an exchange of communication media between a communication client 404a of the client device 102a and a communication client 406a of the endpoint 112a. Similarly, the communication session 402b involves an exchange of communication media between a communication client 404b of the client device 102b and a communication client 406b of the endpoint 112b, and the communication session 402n involves an exchange of communication media between a communication client 404n of the client device 102n and a communication client 406n of the endpoint 112n. Generally, the communication clients 404, 406 represent instances of the communication clients 114 described above.

As further detailed below, the attributes service 118 aggregates attribute values 408 for the communication sessions 402a-402n, and generates different instances of the attribute batches 124 for the communication sessions 402a-402n by applying different instances of the attribute subscriptions 122 to the attribute values 408. The attribute values 408, for instance, represent values for different communication attributes, examples of which introduced above.

Generally, the attributes service 118 can determine the attribute values 408 of the communication sessions 402a-402n in various ways. For instance, in implementations where the communication sessions 402a-402n are managed by the communication service 116, the communication service 116 can observe different attribute values 408 of the communication sessions 402a-402n, and communicate the attribute values 408 to the attributes service 118.

Alternatively or additionally, the attributes service 118 can query various entities for the attribute values 408. For instance, the attributes service 118 can query the endpoint managers 128 and/or the endpoints 112a-112n for attributes of the communication sessions 402a-402n, and the attribute values 408 can be returned to the attributes service 118.

As yet another implementation, the attributes service 118 may have access to various network components of the intermediate networks 110 and/or the endpoint networks 108, and thus may directly observe various communication attributes of the communication sessions 402a-402n. Accordingly, the attributes service 118 may employ a variety of different techniques to obtain and aggregate attribute values for communication attributes of communication sessions.

By applying different instances of the attribute subscriptions 122 to the attribute values 408 extracted from the communication sessions 402a-402n, the attributes service 118 generates different instances of the attribute batches 124. Consider, for example, the following implementation scenario.

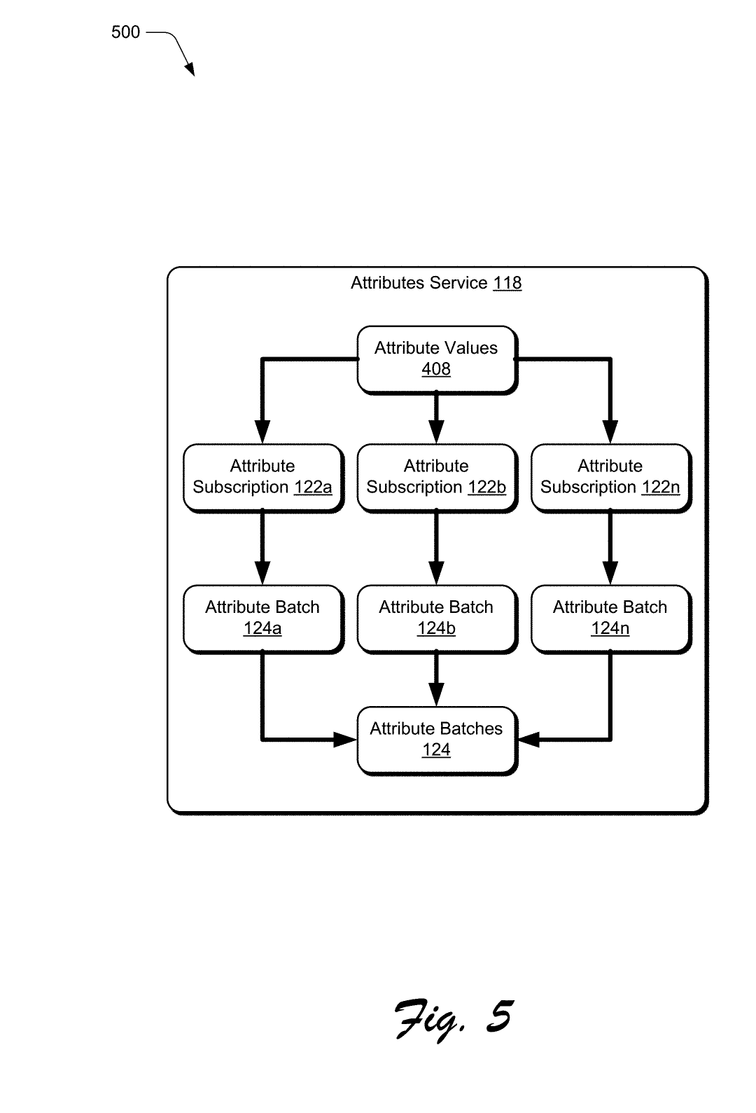

FIG. 5 depicts an example implementation scenario 500 for generating attribute batches based on attribute values and attribute subscriptions in accordance with one or more implementations. The scenario 500, for example, represents an example way of generating instances of the attribute batches 124 introduced above. Further, in at least some implementations, the scenario 500 represents a continuation of the scenarios 200-400, above.

The scenario 500 includes the attribute values 408 aggregated from the communication sessions 402a-402n, as described above. In at least some implementations, the attribute values 408 represent a bulk collection of attribute values across a variety of different devices and subnets. Accordingly, the attributes service 118 applies different attribute subscriptions to the attribute values 408. For instance, the attributes service 118 applies the attribute subscription 122a to the attribute values 408 to generate an attribute batch 124a. As discussed above, the attribute subscription 122a specifies a particular set of communication attributes for the client subnet 106a. Thus, by applying the attribute subscription 122a to the attribute values 408, the attributes service 118 identifies attribute values for communication sessions that traverse the client subnet 106a, e.g., for the communication session 402a. Further, attribute values for communication sessions that do not traverse the subnet 106a are excluded from the attribute batch 124a.

Continuing with the scenario 500, the attributes service 118 applies the attribute subscription 122b to the attribute values 408 to generate an attribute batch 124b, and applies the attribute subscription 122n to the attribute values 408 to generate an attribute batch 124n. The attribute batch 124b, for example, includes attribute values for communication sessions that traverse the client subnet 106b, and the attribute batch 124n includes attribute values for communication sessions that traverse the client subnet 106n. Generally, the attributes service 118 can separate the attribute values 408 into the different subnets in various ways, such as using network identifiers for the different subnets. Accordingly, the attributes service 118 saves the attribute batches 124a-124n to the attribute batches 124.

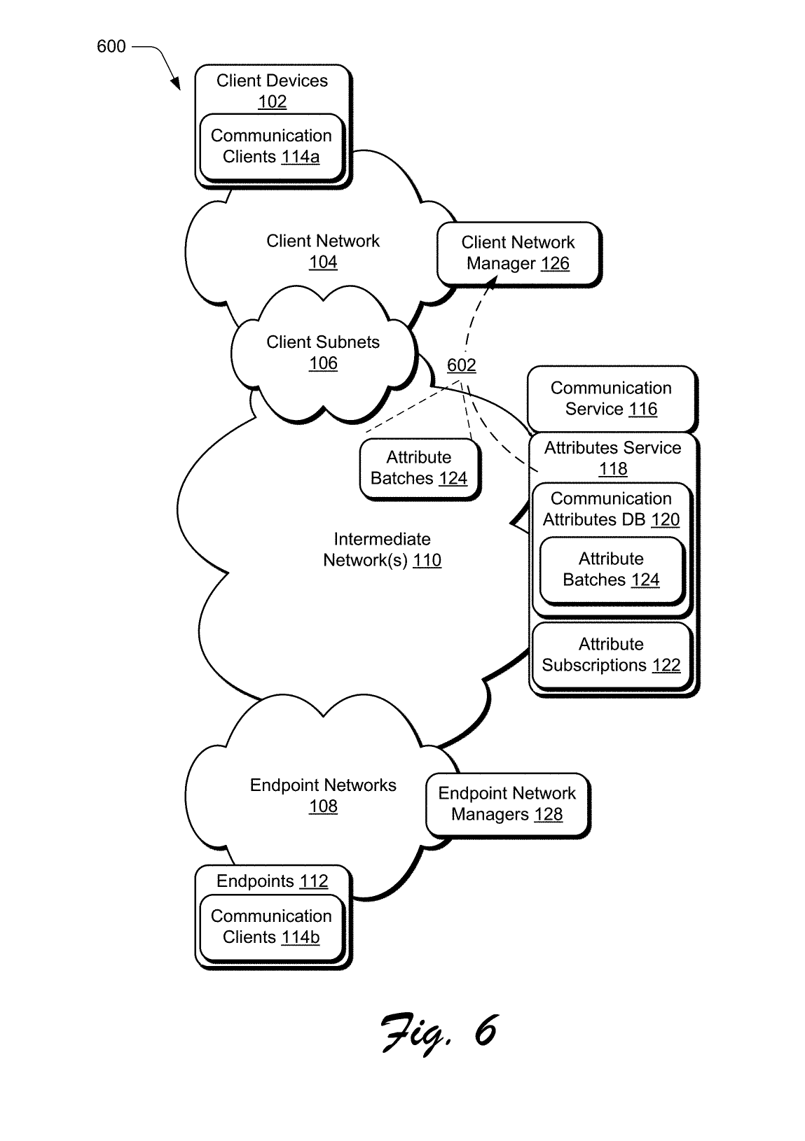

FIG. 6 depicts an example implementation scenario 600 for communicating attribute batches in accordance with one or more implementations. The scenario 600, for example, represents a continuation of the scenarios 200-500, above.

In the scenario 600, the attributes service 118 communicates an attributes event 602 that includes the attribute batches 124 to the client manager 126. The attribute batches 124, for instance, include the attribute batches 124a-124n discussed above.

According to various implementations, the client manager 126 can use the attribute batches 124 to make various decisions and perform various actions based on communication attributes included in the attribute batches 124. For instance, the client manager 126 can cause various actions to be performed to optimize performance of communication sessions between the client devices 102 and the endpoints 112. Examples of such actions include changing a setting of one or more infrastructure components of the client network 104 (e.g., a switch, a router, an access point, and so forth), rerouting communication sessions through different infrastructure components of the client network 104, rerouting communication sessions through different intermediate networks 110, and so forth.

According to various implementations, the different scenarios described above can be performed in real-time to provide a real-time view of communication attributes for communication sessions. For instance, with reference to the scenario 200, the client manager 126 can subscribe to receive different attribute values in real-time, such as prior to, concurrently with, and/or after initiation of a communication session. Further, with reference to the scenarios 300-500, the attributes service 118 can generate attribute subscriptions 122, aggregate attribute values for communication sessions, and apply the attribute subscriptions to the attribute values to generate attribute batches 124 in real-time and while the communication sessions are active. Accordingly, the attributes service 118 can provide the attribute batches to the client manager 126 while the communication sessions are active to enable various actions to be taken to optimize communication session performance in real-time.

Alternatively or additionally, the various scenarios can be performed based on communication attributes for historical communication sessions that are no longer active.

Accordingly, these example scenarios describe that techniques for subscription for communication attributes discussed herein may be employed to subscribe to and propagate communication attributes among various entities involved in a communication system. The communication attributes can be leveraged in various ways, such as for optimizing network performance and performance of communication sessions, mitigating errors that occur and/or may occur in the communication sessions, and so forth.

Having discussed some example implementation scenarios, consider now a discussion of some example procedures in accordance with one or more embodiments.

### Example Procedures

The following discussion describes some example procedures for subscription for communication attributes in accordance with one or more embodiments. The example procedures may be employed in the environment 100 of FIG. 1, the system 900 of FIG. 9, and/or any other suitable environment. The procedures, for instance, represent example procedures for implementing the implementation scenarios described above. In at least some embodiments, the steps described for the various procedures can be implemented automatically and independent of user interaction.

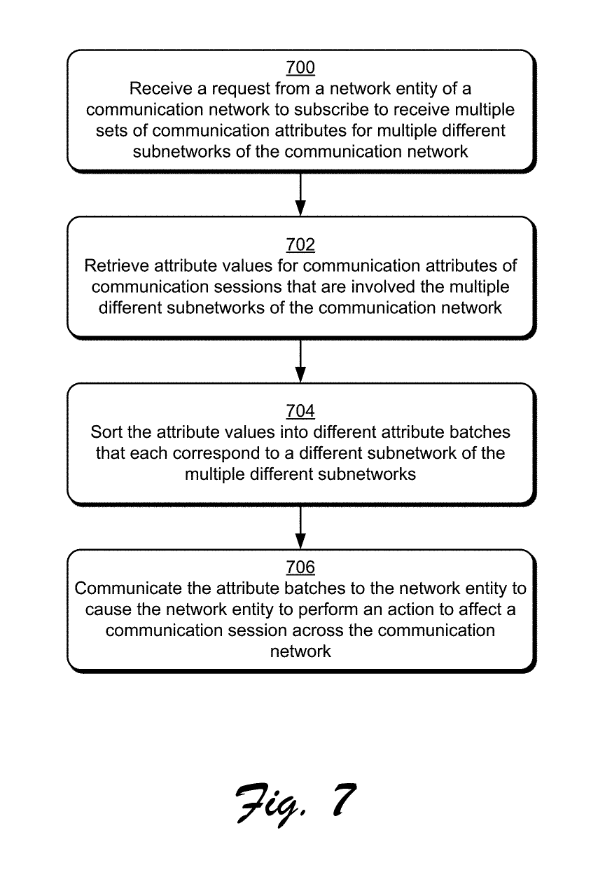

FIG. 7 is a flow diagram that describes steps in a method in accordance with one or more implementations. The method describes an example procedure for aggregating attribute batches in accordance with one or more implementations.

Step 700 receives a request from a network entity of a communication network to subscribe to receive multiple sets of communication attributes for multiple different subnetworks of the communication network. The attributes service 118, for instance, receives a request from the client manager 126 to subscribe to receive values for different communication attributes for different instances of the client subnets 106. Generally, the request identifies different instances of the client subnets 106, and specifies different sets of communication attributes for each of the client subnets 106. In at least some implementations, the attributes service 118 generates an attribute subscription for each of the subnets that specifies the particular set of communication attributes for each of the subnets.

Step 702 retrieves attribute values for communication attributes of communication sessions that are involved the multiple different subnetworks of the communication network. For example, the attributes service 118 retrieves the attribute values in various ways. In at least some implementations, media flows of the communication sessions are visible to the attributes service 118. Thus, the attributes service 118 can directly detect the communication attributes and values for the communication attributes from data of the media flows.

Alternatively or additionally, the attributes service 118 can query another entity involved in the communication sessions for attribute values of the communication sessions. For instance, the attributes service 118 can query the endpoint manager 128 for attribute values for the communication sessions, and the endpoint manager 128 can return the values to the attributes service 118.

Step 704 sorts the attribute values into different attribute batches that each correspond to a different subnetwork of the multiple different subnetworks. The attributes service 118, for instance, applies an attribute subscription 122 for each client subnet 106 to a bulk collection of attribute values to generate an attribute set 204 for each client subnet 106. According to various implementations, each attribute set 204 includes a different respective set of attributes values.

Step 706 communicates the attribute batches to the network entity to cause the network entity to perform an action to affect a communication session across the communication network. The attributes service 118, for instance, communicates the different batches of attributes values to the client manager 126. Alternatively or additionally, the attributes service 118 can communicate the attribute batches to different entities associated with the individual subnets, such as different instances of the client manager 126 that are each deployed to manage different respective instances of the client subnets 106. In at least some implementations, the attribute batches can be configured and communicated by populating values to attributes of the communication API described above.

According to various implementations, the attributes service 118 communicates the attribute batches separately from a data stream of a communication session. For instance, the attribute batches can be transmitted in a separate data stream that is communicated out-of-band from a communication session. As further discussed below, an entity that receives the attributes batches can perform various actions using information from the attribute batches, such as to optimize network performance and/or communication session performance.

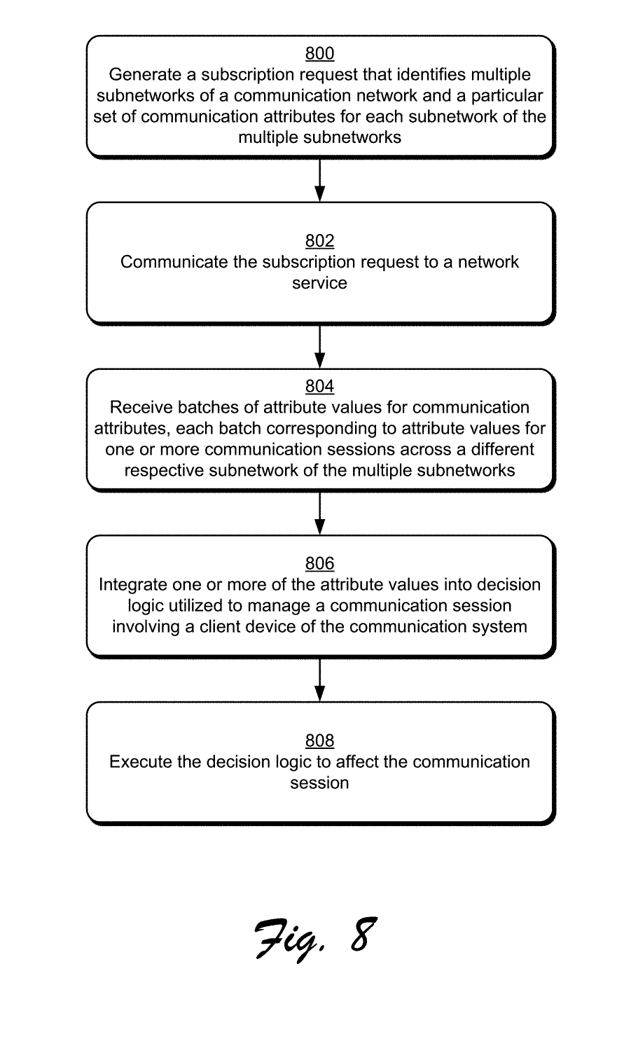

FIG. 8 is a flow diagram that describes steps in a method in accordance with one or more implementations. The method describes an example procedure for subscribing to receive communication attributes in accordance with one or more implementations.

Step 800 generates a subscription request that identifies multiple subnetworks of a communication network and a particular set of communication attributes for each subnetwork of the multiple subnetworks. The client manager 126, for example, generates a subscription request that includes identifiers for multiple of the client subnets 106, and sets of communication attributes for each client subnet 106. In at least some implementations, the subscription request can be formatted using instances of the communication API described above, such as a single instance for each subnet.

In at least some implementations, the subscription request specifies whether and/or what types of Personally Identifiable Information (PII) to be included with the communication attributes. For instance, the subscription request can specify types of PII not to be included with the communication attributes, and/or types of PII to be included with the communication attributes.

Step 802 communicates the subscription request to a network service. The client manager 126, for example, communicates the subscription request to the attributes service 118.

Step 804 receives batches of attribute values for communication attributes, each batch corresponding to attribute values for one or more communication sessions across a different respective subnetwork of the multiple subnetworks. For instance, the client manager 126 receives the attribute batches 124, such as from the attributes service 118. The client manager 126 parses the attribute batches 124 to identify attribute values for each of the subscribed client subnets 106.

Step 806 integrates one or more of the attribute values into decision logic utilized to manage a communication session involving a client device of the communication system. The client manager 126, for example, reconfigures decision logic used to manage communication sessions across one or more of the client subnets 106. For instance, as mentioned above, the client network 104 can be implemented as an SDN. Thus, the client manager 126 utilizes the attributes values as one or more values for internal logic of the client network, such as for configuring infrastructure components of the client network 104 and/or the client subnets 106. Generally, the decision logic represents machine-executable instructions that are executable by the client manager 126 and/or other components of the client network 104.

Step 808 executes the decision logic to affect the communication session. The client manager 126, for example, executes the decision logic to optimize performance of a device (e.g., a client device 102 and/or a network component of the client network 104) and/or a communication session. Alternatively or additionally, executing the decision logic mitigates and/or prevents an error condition. For instance, executing the decision logic can cause an action to be performed, such as changing a setting of a component of the client network 104, changing a setting of a client device 102 and/or a communication client 114, rerouting a communication session within the client network 104 and/or intermediate networks 110, and so forth.

According to various implementations, the procedures described above are performed dynamically and in response to various events. For instance, when an entity ascertains that a communication attribute can be leveraged to perform an action to optimize network and/or communication session performance, the entity can submit a subscription request for the communication attribute according to techniques discussed herein. Thus, the scenarios and procedures described above may be periodically and/or continually performed, such as to maintain current state information across a communication system, to adapt to changing conditions in a communication system, to respond to a decrease in communication quality in a communication system, to mitigate errors in communication data, and so forth. In at least some implementations, the procedures can be performed in real-time to request communication attributes for active communication sessions.

Accordingly, techniques discussed herein provide a wide variety of scenarios and implementations for subscribing to and propagating communication attributes among different entities involved in a communication system. Generally, communication attributes enable such entities to make informed decisions regarding processing, routing, and handling of communication data.

Having discussed some example procedures, consider now a discussion of an example system and device in accordance with one or more embodiments.

### Example System and Device

FIG. 9 illustrates an example system generally at 900 that includes an example computing device 902 that is representative of one or more computing systems and/or devices that may implement various techniques described herein. For example, the client devices 102, the endpoints 112, the client manager 126, and/or the attributes service 118 discussed above with reference to FIG. 1 can be embodied as the computing device 902. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 190 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” “manager,” “controller,” “service,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 190 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 190. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 190 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a wearable device, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the client manager 126 and/or the attributes service 118 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for enabling an action to be performed to optimize a communication session across a communication network, the system including: at least one processor; and one or more computer-readable storage media including instructions stored thereon that, responsive to execution by the at least one processor, cause the system perform operations including: receiving a request from a network entity of a communication network to subscribe to receive multiple sets of communication attributes for multiple different subnetworks of the communication network; retrieving attribute values for communication attributes of communication sessions that are involved the multiple different subnetworks of the communication network; sorting the attribute values into different attribute batches that each correspond to a different subnetwork of the multiple different subnetworks; and communicating the attribute batches to the network entity to cause the network entity to perform an action to optimize performance of a communication session across the communication network.

### Example 2

A system as described in example 1, wherein the request includes network identifiers for the different subnetworks and different sets of communication attributes associated with each of the network identifiers.

### Example 3

A system as described in one or more of examples 1 or 2, wherein the request includes a different attribute set for each subnetwork of the multiple different subnetworks, and the operations further include generating an attribute subscription for each subnetwork that includes the attribute set received for the respective subnetwork.

### Example 4

A system as described in one or more of examples 1-3, wherein the request includes a different attribute set for each subnetwork of the multiple different subnetworks, the operations further include generating an attribute subscription for each subnetwork that includes the attribute set received for the respective subnetwork, and wherein said sorting includes applying the attribute values to each attribute subscription to generate the attribute batches.

### Example 5

A system as described in one or more of examples 1-4, wherein the operations are performed by a cloud service remote from the communication network.

### Example 6

A system as described in one or more of examples 1-5, wherein the attributes values are retrieved in real-time while at least some of the communication sessions are active.

### Example 7

A system as described in one or more of examples 1-6, wherein the communication sessions represent historical communication sessions, and the attributes values are retrieved in after the communication sessions terminated.

### Example 8

A system as described in one or more of examples 1-7, wherein one or more of the communication sessions involve a different network than the communication network, and wherein said retrieving includes querying the different network for one or more of the attribute values for the one or more of the communication sessions.

### Example 9

A system as described in one or more of examples 1-8, wherein one or more of the communication sessions is implemented via a cloud-based communication service, and wherein said retrieving includes querying the cloud-based communication service for one or more of the attribute values for the one or more of the communication sessions.

### Example 10

A system as described in one or more of examples 1-9, further including generating the attribute batches using an application programming interface (API) that is populated with the attribute values for each subnetwork of the multiple different subnetworks.

### Example 11

A computer-implemented method for optimizing decision logic for a communication session across one or more subnetworks, the method including: generating a subscription request that identifies multiple subnetworks of a communication network and a particular set of communication attributes for each subnetwork of the multiple subnetworks; communicating the subscription request to a network service; receiving batches of attribute values for communication attributes, each batch corresponding to attribute values for one or more communication sessions across a different respective subnetwork of the multiple subnetworks; integrating one or more of the attribute values into decision logic utilized to manage a communication session involving a client device of the communication system; and executing the decision logic to affect the communication session.

### Example 12

A method described in example 11, wherein said generating uses an application programming interface (API) that is populated with the particular set of communication attributes for each subnetwork of the multiple subnetworks.

### Example 13

A method described in one or more of examples 11 or 12, wherein the subscription request specifies different sets of communication attributes for at least some of the subnetworks.

### Example 14

A method described in one or more of examples 11-13, wherein the subscription request specifies a particular type of Personally Identifiable Information (PII) to not be included with the communication attributes.

### Example 15

A method described in one or more of examples 11-14, wherein said executing implements an optimization procedure to attempt to optimize performance of the communication session.

### Example 16

A method described in one or more of examples 11-15, wherein said executing implements an optimization procedure to attempt to optimize performance of a particular subnetwork.

### Example 17

A computer-implemented method for optimizing performance of a communication session, including: receiving a request from a network entity of a communication network to subscribe to receive multiple sets of communication attributes for multiple different subnetworks of the communication network; retrieving, in real-time, attribute values for communication attributes of communication sessions that are involve the multiple different subnetworks of the communication network and while the communication sessions are active; sorting the attribute values into different attribute batches that each correspond to a different subnetwork of the multiple different subnetworks; and communicating, in real-time while the communication sessions are active, the attribute batches to the network entity to cause the network entity to perform an action to optimize a communication session across the communication network.

### Example 18

A method as described in example 17, wherein said retrieving is based on direct observation of one or more of the communication sessions by a communication service involved in the one or more communication sessions.

### Example 19

A method as described in one or more of examples 17 or 18, wherein one or more of the communication sessions involve a different network than the communication network, and wherein said retrieving includes querying the different network for one or more of the attribute values for the one or more of the communication sessions.

### Example 20

A method as described in one or more of examples 17-19, wherein said communicating includes communicating the attribute batches in one or more data streams that are separate from media streams of the communication sessions.

### CONCLUSION

Techniques for subscription for communication attributes are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
receiving a request from a network entity of a communication network to subscribe to receive multiple sets of communication attributes for multiple different subnetworks of the communication network;
retrieving attribute values for communication attributes of communication sessions that are involved the multiple different subnetworks of the communication network;
sorting the attribute values into different attribute batches that each correspond to a different subnetwork of the multiple different subnetworks; and
communicating the attribute batches to the network entity to cause the network entity to perform an action to optimize performance of a communication session across the communication network.

2. A system as described in claim 1, wherein the request includes network identifiers for the different subnetworks and different sets of communication attributes associated with each of the network identifiers.

3. A system as described in claim 1, wherein the request includes a different attribute set for each subnetwork of the multiple different subnetworks, and the operations further include generating an attribute subscription for each subnetwork that includes the attribute set received for the respective subnetwork.

4. A system as described in claim 1, wherein the request includes a different attribute set for each subnetwork of the multiple different subnetworks, the operations further include generating an attribute subscription for each subnetwork that includes the attribute set received for the respective subnetwork, and wherein said sorting comprises applying the attribute values to each attribute subscription to generate the attribute batches.

5. A system as described in claim 1, wherein the operations are performed by a cloud service remote from the communication network.

6. A system as described in claim 1, wherein the attributes values are retrieved in real-time while at least some of the communication sessions are active.

7. A system as described in claim 1, wherein the communication sessions represent historical communication sessions, and the attributes values are retrieved in after the communication sessions terminated.

8. A system as described in claim 1, wherein one or more of the communication sessions involve a different network than the communication network, and wherein said retrieving comprises querying the different network for one or more of the attribute values for the one or more of the communication sessions.

9. A system as described in claim 1, wherein one or more of the communication sessions is implemented via a cloud-based communication service, and wherein said retrieving comprises querying the cloud-based communication service for one or more of the attribute values for the one or more of the communication sessions.

10. A system as described in claim 1, further comprising generating the attribute batches using an application programming interface (API) that is populated with the attribute values for each subnetwork of the multiple different subnetworks.

11. A computer-implemented method comprising:
generating a subscription request that identifies multiple subnetworks of a communication network and a particular set of communication attributes for each subnetwork of the multiple subnetworks;
communicating the subscription request to a network service;
receiving batches of attribute values for communication attributes, each batch corresponding to attribute values for one or more communication sessions across a different respective subnetwork of the multiple subnetworks;
integrating one or more of the attribute values into decision logic utilized to manage a communication session involving a client device of the communication system; and
executing the decision logic to affect the communication session.

12. A method recited in claim 11, wherein said generating uses an application programming interface (API) that is populated with the particular set of communication attributes for each subnetwork of the multiple subnetworks.

13. A method recited in claim 11, wherein the subscription request specifies different sets of communication attributes for at least some of the subnetworks.

14. A method recited in claim 11, wherein the subscription request specifies a particular type of Personally Identifiable Information (PII) to not be included with the communication attributes.

15. A method recited in claim 11, wherein said executing implements an optimization procedure to attempt to optimize performance of the communication session.

16. A method recited in claim 11, wherein said executing implements an optimization procedure to attempt to optimize performance of a particular subnetwork.

17. A computer-implemented method, comprising:
receiving a request from a network entity of a communication network to subscribe to receive multiple sets of communication attributes for multiple different subnetworks of the communication network;
retrieving, in real-time, attribute values for communication attributes of communication sessions that are involve the multiple different subnetworks of the communication network and while the communication sessions are active;
sorting the attribute values into different attribute batches that each correspond to a different subnetwork of the multiple different subnetworks; and
communicating, in real-time while the communication sessions are active, the attribute batches to the network entity to cause the network entity to perform an action to optimize a communication session across the communication network.

18. A method as recited in claim 17, wherein said retrieving is based on direct observation of one or more of the communication sessions by a communication service involved in the one or more communication sessions.

19. A method as recited in claim 17, wherein one or more of the communication sessions involve a different network than the communication network, and wherein said retrieving comprises querying the different network for one or more of the attribute values for the one or more of the communication sessions.

20. A method as recited in claim 17, wherein said communicating comprises communicating the attribute batches in one or more data streams that are separate from media streams of the communication sessions.
